(19) United States
(12) Patent Application Publication
(10) Pub. No.: US 2012/0229823 A1
(43) Pub. Date: Sep. 13, 2012

(54) OUTPUT APPARATUS, SYSTEM, CONTROL METHOD, AND STORAGE MEDIUM STORING A PROGRAM

(75) Inventor: Junji Sato, Kawasaki-shi (JP)

(73) Assignee: CANON KABUSHIKI KAISHA, Tokyo (JP)

(21) Appl. No.: 13/413,939

(22) Filed: Mar. 7, 2012

(30) Foreign Application Priority Data
Mar. 11, 2011 (JP) 2011-054464
Feb. 13, 2012 (JP) 2012-028889

(51) Int. Cl. G06K 15/02

(52) U.S. Cl. 358/1.6

(57) ABSTRACT

An output apparatus includes a generation unit configured to generate a two-dimensional code by encoding information indicative of the output apparatus, information indicative of an output time of an image output by the output apparatus, and information indicative of a page number and a print copy number when the image is output, a combining unit configured to combine the generated two-dimensional code with the image, and an output unit configured to output the image including the two-dimensional code.

### BACKGROUND OF THE INVENTION

1. Field of the Invention

The present invention relates to an output apparatus, a system, a control method, and a storage medium storing a computer-readable program.

2. Description of the Related Art

A technique used for printing an ID which is useful for identification of each printed output from others is being proposed. Since this technique is not open to the public yet, it is not known to the public.

However, according to this technique discussed in Japanese Patent Application No. 2010-202118, a region in a two-dimensional code used for writing the ID on the printed output is necessary.

### SUMMARY OF THE INVENTION

The present invention is directed to an output apparatus.

According to an aspect of the present invention, an output apparatus includes a generation unit configured to generate a two-dimensional code by encoding information indicative of the output apparatus, information indicative of an output time of an image output by the output apparatus, and information indicative of a page number and a print copy number when the image is output, a combining unit configured to combine the generated two-dimensional code with the image, and an output unit configured to output the image including the two-dimensional code.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a document management system according to the present invention.

FIG. 2 illustrates an example of a hardware configuration of a personal computer (PC) and a server in the document management system.

FIG. 3 illustrates an example of a hardware configuration of a multifunction peripheral (MFP) in the document management system.

FIG. 4 illustrates an example of a software configuration of the document management system.

FIG. 5 illustrates an example of a document including an encoded image.

FIG. 6 is a flowchart illustrating a copy operation performed by the MFP.

FIG. 7 illustrates an example of embedded information obtained according to decode processing.

FIGS. 8A, 8B, and 8C illustrate examples of updated embedded information.

FIG. 9 is a flowchart illustrating a processing flow of the MFP printing image data sent from the PC.

FIGS. 10A, 10B, and 10C illustrate examples of embedded information sent from the MFP to the server.

FIGS. 11A, 11B, and 11C illustrate examples of a data table generated by the server.

FIG. 12 is a flowchart illustrating a processing flow of the server performing tracing.

FIGS. 13A and 13B illustrate, respectively, an example of a trace target and an example of a trace result list.

FIG. 14 is a flowchart illustrating a processing flow of the server performing the tracing.

FIGS. 15A and 15B illustrate examples of a trace target and of a trace result list, respectively.

FIG. 16 is a flowchart illustrating a processing flow of the server performing following trace processing.

FIGS. 17A and 17B illustrate examples of a following trace target and of a trace result list, respectively.

FIGS. 18A and 18B are flowcharts illustrating a processing flow of the server performing full tracing.

FIG. 19 illustrates an example of a processing result of the full tracing.

### DESCRIPTION OF THE EMBODIMENTS

Various exemplary embodiments, features, and aspects of the invention will be described in detail below with reference to the drawings.

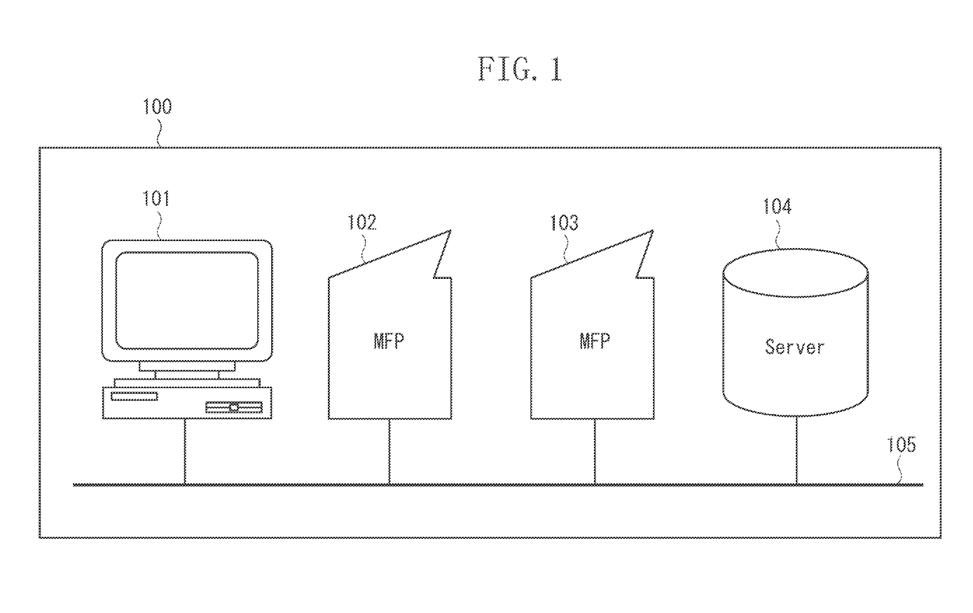

FIG. 1 illustrates an example of a configuration of a document management system 100 according to the present invention.

The document management system 100 includes a PC 101, a MFP 102, a MFP 103, and a server 104. These apparatuses are mutually connected via a network 105 such as a local area network (LAN).

The PC 101 is an information processing apparatus such as a personal computer. The PC 101 includes a central processing unit (CPU), a random access memory (RAM), a read only memory (ROM), a hard disk drive, an external storage unit, a network interface, a display, a keyboard, and a mouse.

The MFPs 102 and 103 are image forming apparatuses having a scanner function, a copy function, a print function, and a transmission function.

The image forming apparatus is not limited to a MFP and any type of apparatus can be used so long as it can form an image in a memory or on a sheet. Further, although two MFPs 102 and 103 are in the document management system in FIG. 1, one or three MFPs can be included in the system.

The server 104 is an information processing apparatus which stores various files and data transmitted from the PC 101, the MFP 102, or the MFP 103.

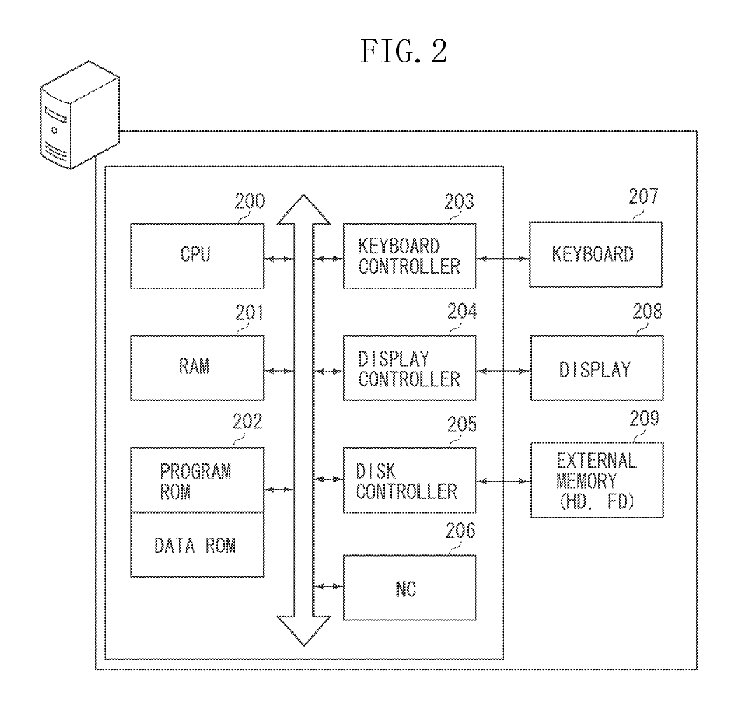

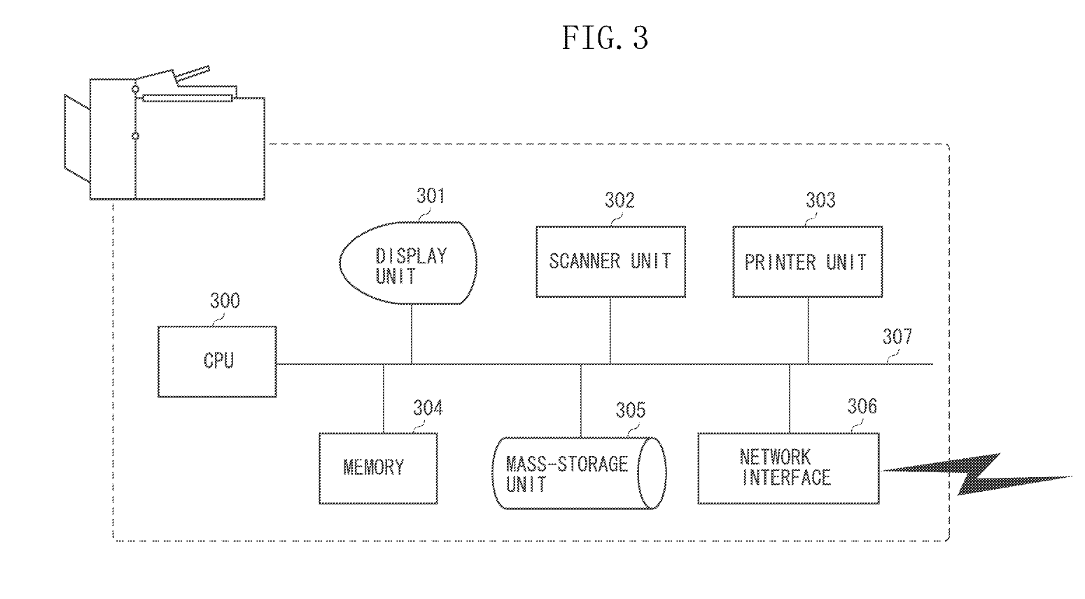

FIG. 2 illustrates an example of a hardware configuration of the PC 101 and the server 104. FIG. 3 illustrates an example of a hardware configuration of the MFPs 102 and 103.

In FIG. 2, a CPU 200 executes a program such as an operating system (OS) or an application stored in a program ROM of a ROM 202 or in a hard disk 209. The program is loaded into a RAM 201 and executed by the CPU 200.

The RAM 201 functions as a main memory and a work area of the CPU 200. A keyboard controller 203 controls input of a key via a keyboard 207 or a pointing device (not illustrated).

A display controller 204 controls display of a display 208. A disk controller 205 controls data access to a hard disk (HD) 209 or a floppy (registered trademark) disk (FD) storing various types of data. A network controller (NC) 206 is connected to a network and executes control processing regarding communication with another apparatus connected to the network.

In FIG. 3, a CPU 300 is a processor that performs overall control of the MFPs 102 and 103. Each unit of the MFPs is connected to an internal bus 307 and controlled by the CPU 300. A display unit 301 includes an image display device such as a touch panel. A user gives, for example, a copy instruction via a screen displayed on the display unit 301.

A scanner unit 302 scans a document and acquires image data. A printer unit 303 prints an image on a recording medium such as paper.

A memory 304 stores various commands (including an application program) which are executed when the CPU 300 controls the MFPs 102 and 103. Image data acquired by the scanner unit 302 is temporarily stored in a mass-storage unit 305. A network interface 306 performs transmission/reception of various types of data via the network 105 according to the control of the CPU 300.

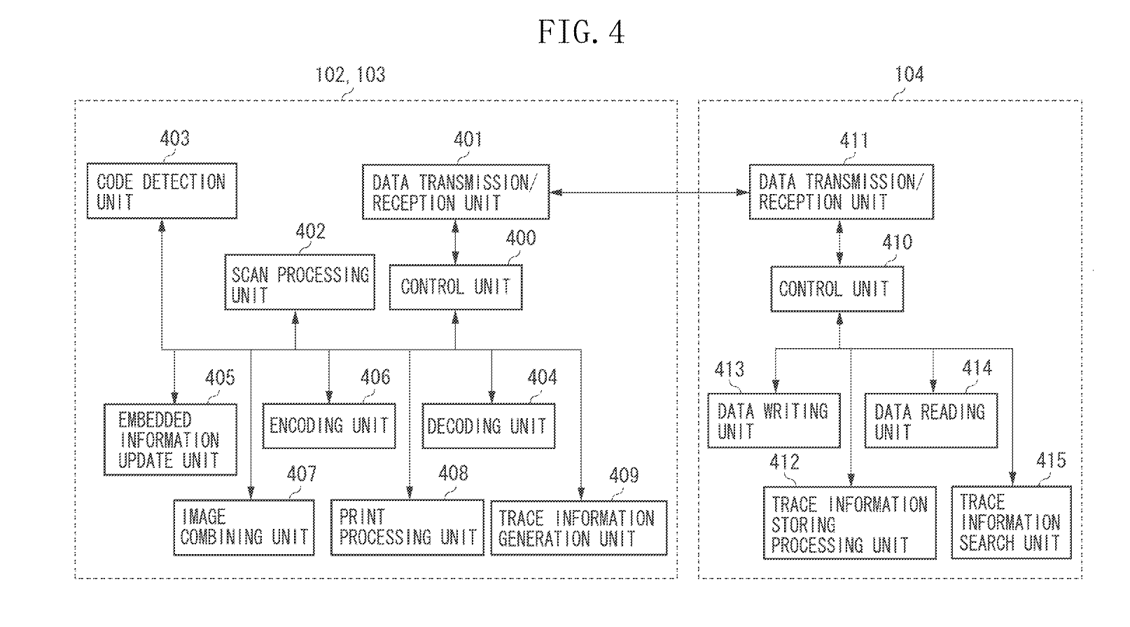

FIG. 4 illustrates an example of a software configuration of the document management system. A broken line in FIG. 4 separates the software configurations of the MFP 102 or 103 and the server 104. The software configuration of each apparatus of the document management system is realized by a CPU of each apparatus executing a program stored in a storage unit (RAM, external memory, mass storage apparatus, memory, or the like) of the apparatus.

First, the software configuration of the MFP 102 or 103 will be described.

A control unit 400 performs overall control of the MFP 102 or 103, gives instructions to each unit described below, and performs management of the each unit. A data transmission/reception unit 401 performs transmission/reception of data with the server 104. The data transmission/reception unit 401 also performs transmission/reception processing of data with the PC 101 although it is not described in the present embodiment. The reception processing is also referred to as acquisition processing.

A scan processing unit 402 causes the scanner unit 302 to scan a document set on a platen according to an instruction given by the user via a user interface (UI) and acquires image data as a result of the scanning.

A code detection unit 403 detects a QR code from the image data acquired as a result of the scanning. In this specification, although a QR code being a typical two-dimensional code is described as an example of a coded image attached to the document, the coded image is not limited to a QR code. For example, the present invention can be broadly applied to a technique that allows addition of a specific-information-encoded image to a document for purposes such as document management and copy limitation. Such an image including specific information is, for example, an one-dimensional code or a digital watermark.

Further, in this specification, a “document” is a term used for a printed output or a copied output on which specific information including a character or a figure is printed.

Furthermore, in this specification, “content” is a term used for expressing specific information including a character or a figure on a printed output or a copied output. If a copy of a printed output A is made, the obtained copy (copied output B) and the printed output A are considered as different documents. However, since characters and figures included in the printed output A and the copied output B are the same, they have the same content.

A decoding unit 404 decodes a detected QR code and extracts embedded information.

An embedded information update unit 405 updates the embedded information and generates new information to be embedded in the copied document. If the embedded information does not exist (e.g., the original document copy does not include a QR code), the embedded information update unit 405 newly generates information to be embedded.

An encoding unit 406 encodes the updated embedded information or the newly-generated information to be embedded and generates a QR code as an encoded image.

An image combining unit 407 combines the image data to be printed and the QR code which has been generated by the encoding processing.

A print processing unit 408 causes the printer unit 303 to print the image data obtained according to the combining processing on a recording medium such as paper.

A trace information generation unit 409 generates trace information based on the embedded information extracted by the decoding unit 404 and the new information to be embedded generated by the embedded information update unit 405. The trace information is used for tracing use history of the printed output.

Next, the software configuration of the server 104 will be described.

A control unit 410 performs overall control of the server 104. The control unit 410 gives instructions to each unit of the server 104 described below and performs management of each unit.

A data transmission/reception unit 411 performs data transmission/reception with the MFP 102 or 103. Further, although not illustrated in FIG. 4, the data transmission/reception unit 411 performs data transmission/reception processing with the PC 101.

A trace information storing processing unit 412 performs various types of processing necessary for the registration of the trace information received from the MFP 102 or 103 based on the instruction given by the control unit 410.

A data writing unit 413 writes various types of data other than the trace information, based on the instruction given by the control unit 410, in a hard disk (not illustrated) or the like and stores the data.

A data reading unit 414 reads out various types of data including the trace information from a hard disk (not illustrated) based on an instruction given by the control unit 410.

According to an instruction given by the control unit 410, a trace information search unit 415 performs various types of processing necessary for the search of trace information stored in the hard disk using the search information received by the data transmission/reception unit 411.

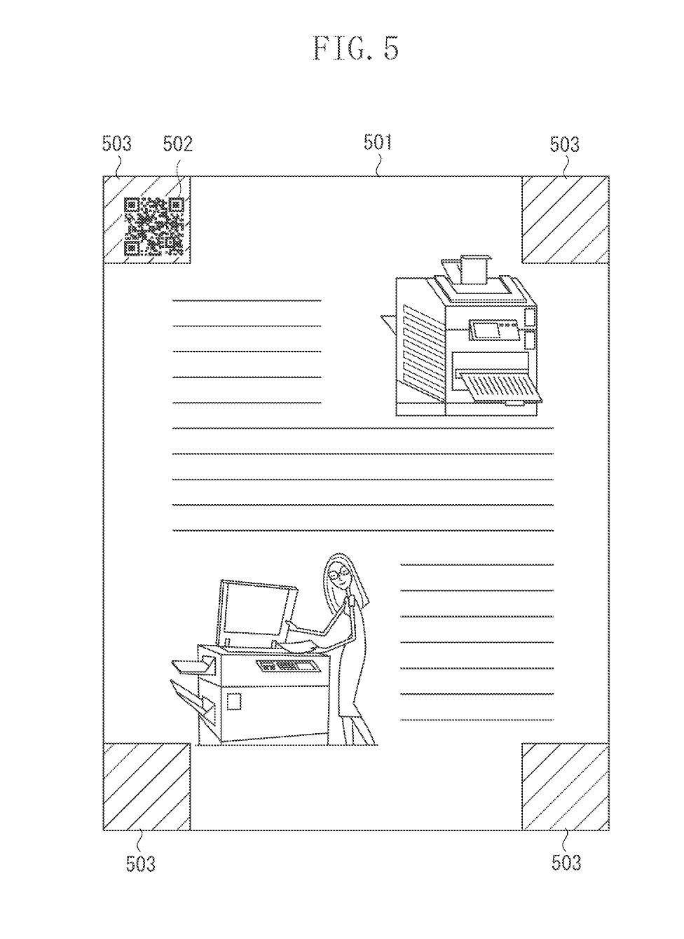

FIG. 5 illustrates an example of a document including an encoded image. The document is to be scanned according to the present invention.

In FIG. 5, a QR code 502 is printed on a document 501. The QR code 502 is an encoded image obtained by the encoding of the embedded information. The QR code is printed in a predetermined region of the recording medium. According to the present embodiment, the QR code is printed in one region out of rectangular regions 503 provided at the upper left corner, the lower left corner, the upper right corner, and the lower right corner of the document 501. The region where the QR code is printed goes under the QR code detection processing.

The rectangular region is, for example, a 30-mm square. The region where the QR code is printed is not limited to such an area, and the position, the shape, and the size can be arbitrarily set.

The embedded information includes, for example, the following information.

print copy number of a document

page number of the document

latest user information used for identifying the last user who has instructed output of the document

original user information used for identifying the first user who has instructed output of the content

date and time information used for identifying the date and time when the document has been output

apparatus information used for identifying the MFP that has output the document

The content of the embedded information is not limited to the above-described information. For example, information indicating whether image data transmitted from the PC is to be printed or information indicating whether the document set on the platen is to be copied can be added to the embedded information as needed. Further, not only apparatus information useful in identifying the MFP which has output the document but also information useful in identifying the first apparatus which has output the content can be added to the embedded information. If such information is added to the embedded information, the apparatus information useful in identifying the MFP which has output the document will be the latest apparatus information and the information useful in identifying the first apparatus which has output the content will be the original apparatus information.

The print copy number used here is information indicating what number of the print copy the document has been output in the print or the copy processing. Further, the page number is information indicating the page number of the document output in the print or the copy processing.

For example, if two sets of a document including three pages are printed, the print copy number and the page number embedded in the six sheets will be as follows:

printed output 1: print copy number=1, page number=1

printed output 2: print copy number=1, page number=2

printed output 3: print copy number=1, page number=3

printed output 4: print copy number=2, page number=1

printed output 5: print copy number=2, page number=2

printed output 6: print copy number=2, page number=3

Thus, regarding the printed output obtained in one printing or copying operation, there is no printed output having a same combination of the print copy number and the page number. If two-sided printing is performed, a different page number is printed on each side of the sheet.

Next, the copy operation of the MFP 102 or 103 will be described.

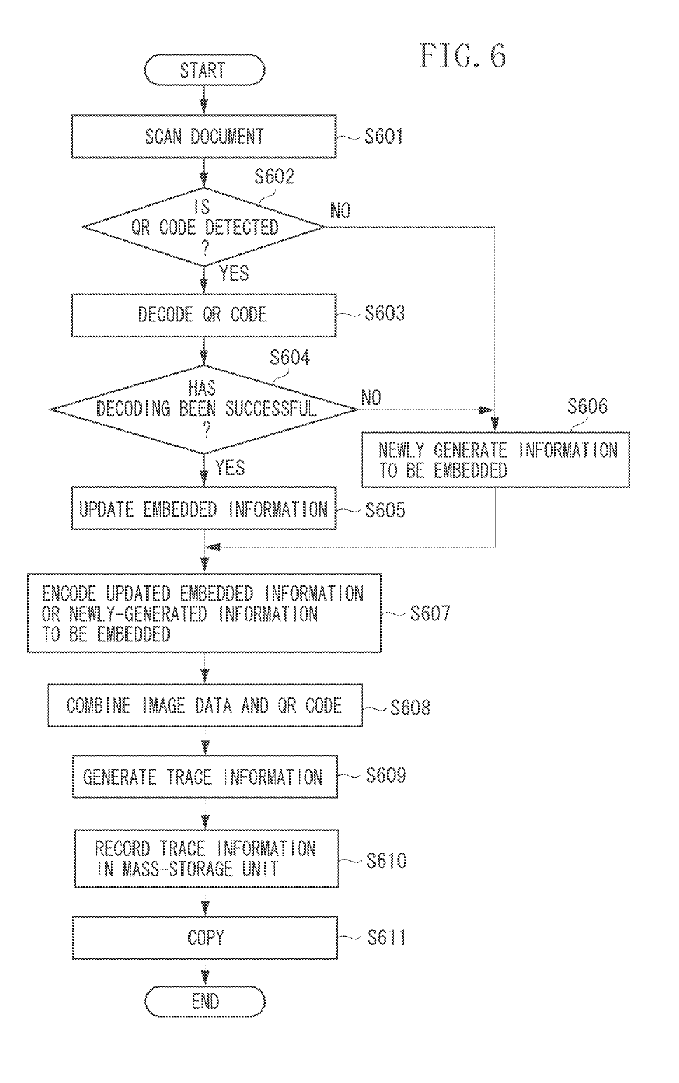

FIG. 6 is a flowchart illustrating the copy processing of the MFP 102 or 103. According to the present embodiment, an application (program), which is stored in the memory 304, starts according to an instruction given by the user and each of the steps described below is realized by the CPU 300 executing the application.

In step S601, when the user sets a document to be copied on the platen of the MFP 102 or 103 and selects a copy button (not illustrated), the scan processing unit 402 instructs the scanner unit 302 to scan the document. In this manner, a piece of image data is acquired.

Although the document to be scanned is called an “original document”, the original document itself can be a copied document. (For example, a copied document is to be copied again.)

In step S602, the code detection unit 403 detects a QR code from the acquired image data. In other words, the code detection unit 403 detects whether a QR code is in one region out of the above-described rectangular regions at the four corners of the acquired image. If a QR code is detected (YES in step S602), the processing proceeds to step S603.

In step S603, the decoding unit 404 decodes the detected QR code. In other words, the decoding unit 404 decodes the QR code and extracts the embedded information.

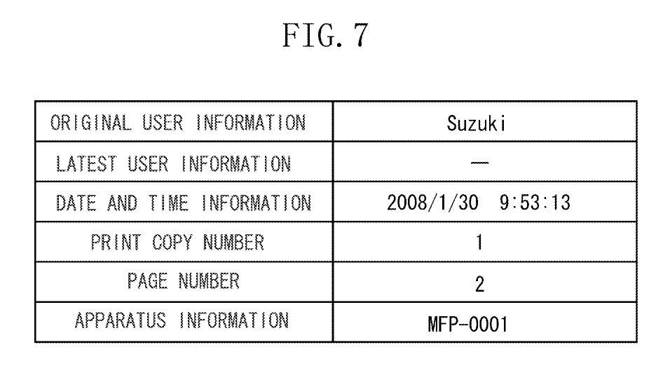

FIG. 7 illustrates an example of the embedded information (first information) extracted by the decoding processing.

According to the example in FIG. 7, user information “Suzuki”, date and time information “2008/01/30 09:53:13”, print copy number “1”, page number “2”, and apparatus information “MPF-0001” are extracted. The user information “Suzuki” is information indicative of the user who has instructed printing of the original document. The date and time information “2008/01/30 09:53:13” is the date and time (YYYYMMDD hhmmss) when the original document has been output. “1” is the print copy number of the original document and “2” is the page number of the original document. “MPF-0001” is the MFP which has output the original document. The column of “latest user information” is blank since the document is the first output of the content and is not a copied document (i.e., original document).

If the original document is copied by a user in the past, user information indicative of the last user who has made the copy will be displayed in the “latest user information” column. “Apparatus information” further includes, for example, both the information used for identifying a manufacturer (vendor) of the apparatus and a serial number of the apparatus.

In step S604, the embedded information update unit 405 determines whether the decoding has been successfully accomplished and the embedded information has been extracted. If the embedded information has been successfully decoded (YES in step S604), the processing proceeds to step S605. If the embedded information has not been successfully decoded due to, for example, stain of the QR code (NO in step S604), the processing proceeds to step S606.

In step S605, the embedded information update unit 405 updates the embedded information (first information) extracted in step S603. To be more precise, the embedded information update unit 405 maintains the user information indicative of the user who has generated the original document (i.e., information extracted as the “original user information”) as the “original user information” and user information indicative of the user who has instructed the copying this time is set as the “latest user information”. If the “latest user information” is included in the embedded information extracted in step S603, since the user information indicative of the user who has instructed the copying this time is set as the “latest user information”, the former “latest user information” will be deleted.

Further, the date and time information of the copying performed this time, the number of pages copied, the print copy number, and the page number corresponding to the copied output are assigned and the embedded information is updated.

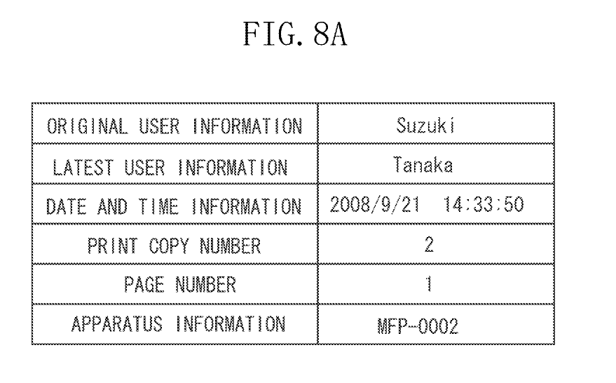

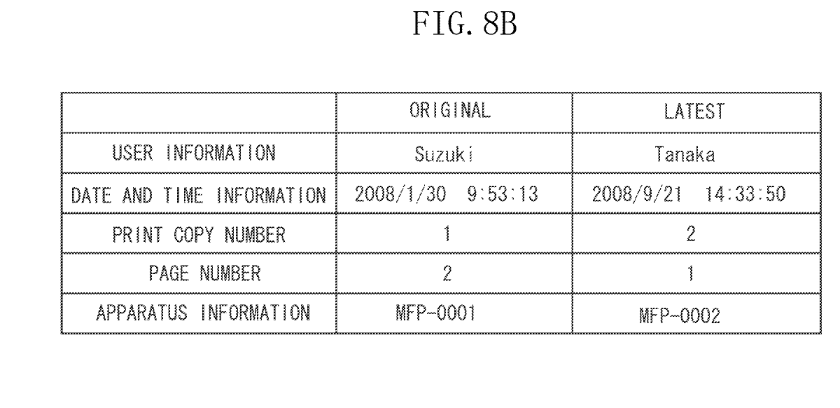

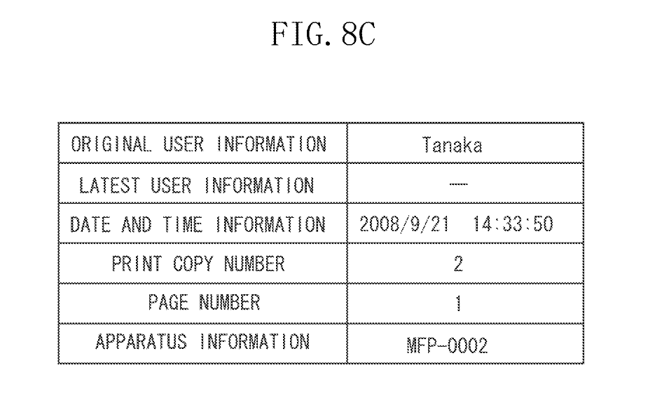

FIG. 8A illustrates the embedded information after it is updated in step S605. This information is referred to as second information. The embedded information before the update is the information illustrated in FIG. 7.

User information “Tanaka” which indicates the name of the user who has performed the copying is displayed in the “latest user information” column, and user information “Suzuki” which indicates the name of the user who has generated the original document is displayed in the “original user information” column. Further, it is understood from the information that the copying has been performed by “Tanaka” at “2008/09/21 14:33:50” and the print copy number and the page number of the copied document are “2” and “1”, respectively. Furthermore, the copying has been performed by “MFP-0002”.

The embedded information can be updated while maintaining the “Original” information if such information is included in addition to the user information.

FIG. 8B illustrates an example of the embedded information including the “Original” information. The “Original” information indicates the embedded information when the original document has been output the first time. Further, the “Latest” indicates the information of the copying performed this time.

On the other hand, if a QR code is not detected in step S602 (NO in step S602) or if the decoding fails in step S604 (NO in step S604), the processing proceeds to step S606. In step S606, the embedded information update unit 405 newly generates information to be embedded in the document output by the copy processing.

FIG. 8C illustrates an example of the newly-generated information to be embedded generated in step S606. Since the information is newly generated, “Tanaka”, which is the name of the user who has instructed the copying this time, is in the column of the “original user information” instead of the column of the “latest user information”.

In step S607, the encoding unit 406 encodes the embedded information updated in step S605 (second information) or the information to be embedded newly generated in step S606 and generates a QR code.

In step S608, the image combining unit 407 combines the generated QR code and the image data obtained in step S601. If a QR code is included in the original document, the QR code of the combined image data corresponds to the updated embedded information. If a QR code is not included in the original document, the QR code of the combined image data corresponds to the newly-generated QR code.

In step S609, if the detection of the QR code has been successful in step S602 and if the decoding has been successful in step S604, the trace information generation unit 409 generates trace information based on the embedded information (first information) extracted in step S603 and the embedded information (second information) updated in step S605.

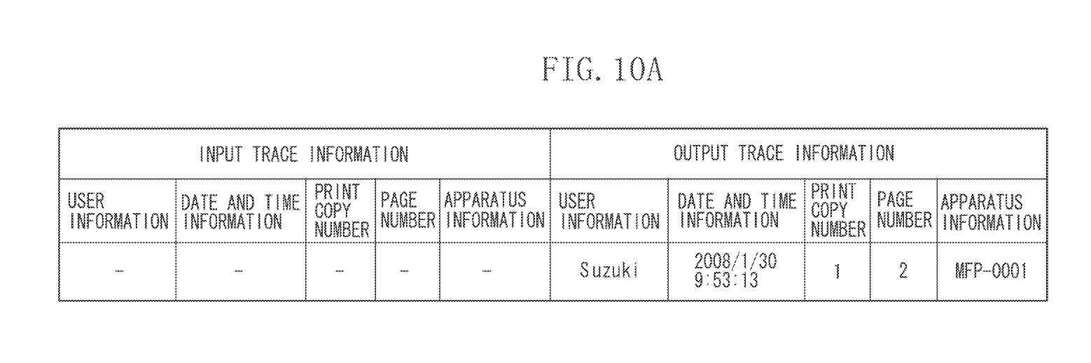

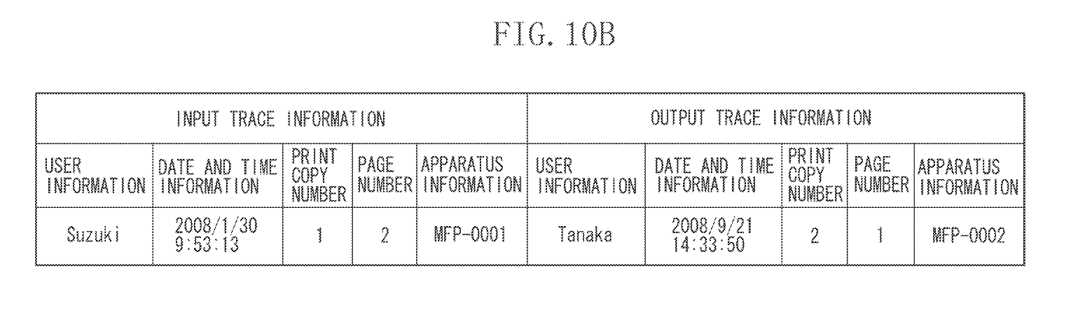

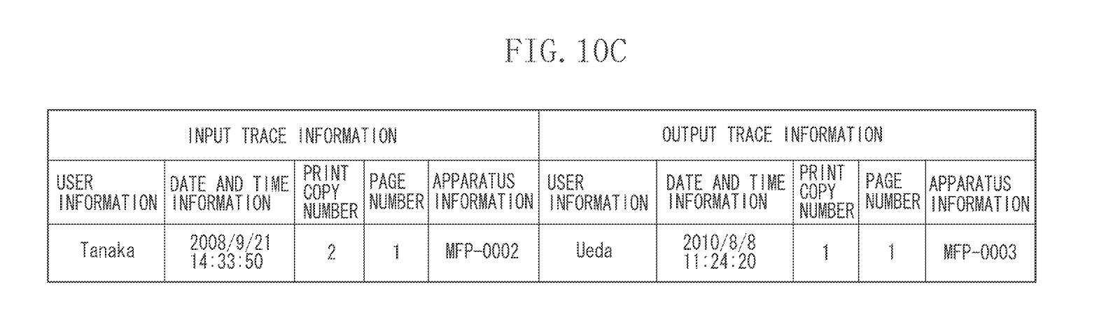

On the other hand, if the detection of the QR code has been unsuccessful in step S602 or if the decoding has been unsuccessful in step S604, trace information will be generated based on the information to be embedded newly generated in step S606. Details of the trace information will be described below with reference to FIG. 10.

In step S610, the trace information generation unit 409 records the trace information generated in step S609 in the mass-storage unit 305. The trace information which has been recorded is later transmitted to the server 104 by the data transmission/reception unit 401 at predetermined timing (periodically or at a predetermined amount).

The trace information is not necessarily recorded in the mass-storage unit 305 and can be transmitted to the server 104 each time the copying operation is performed. Further, in place of the MFP transmitting the trace information to the server 104, the server 104 or an external application (not illustrated) can access the MFP and acquire the trace information.

In step S611, the print processing unit 408 forms an image based on the generated combined image data and outputs the image on a recording medium such as paper. Then, the copy of the document is discharged on a discharge tray (not illustrated).

If the copy processing is to be given priority over other processing such as trace information generation processing or trace information record processing, the copy processing in step S611 can be executed prior to or in parallel with the trace information generation processing in step S609 and the trace information record processing in step S610.

Next, a case where print processing of image data obtained from the PC 101 will be described.

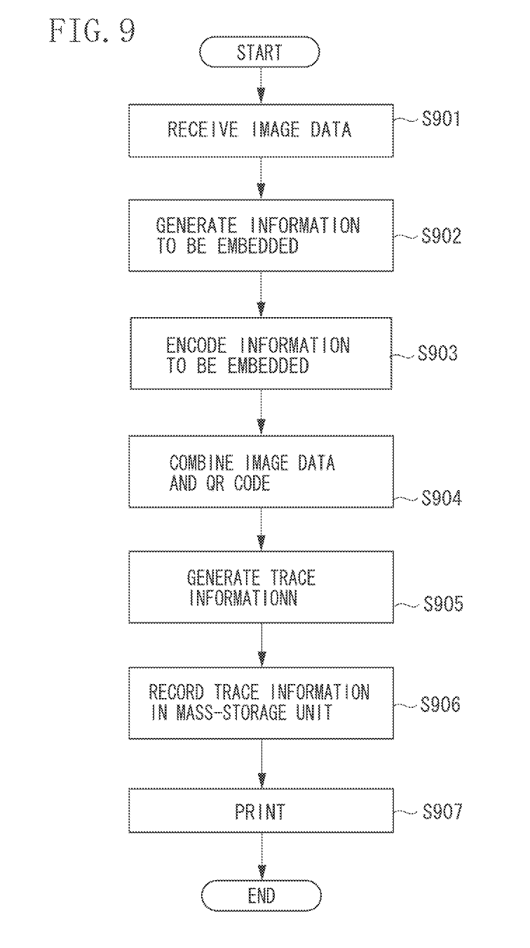

FIG. 9 is a flowchart illustrating print processing performed by the MFP 102 or 103 based on the image data transmitted from the PC 101. As is the case with the copy processing described with reference to FIG. 6, each step of the processing is realized when the CPU 300 executes an application (program) stored in the memory 304 according to the starting operation of the user.

In step S901, when the user gives a print instruction via the PC 101, the data transmission/reception unit 401 receives image data from the PC 101. The received image data (bitmap data) has undergone, for example, rasterization processing and is in a state appropriate for printing.

If the received image data is written in page description language (PDL), the image data is processed so that the data is appropriate for printing. For example, interpretation of the PDL data or rasterization is performed by an image processing unit (not illustrated) in parallel with the processing in steps S902 and S903 described below.

In step S902, the embedded information update unit 405 generates information to be embedded in the document to be printed. The information is, for example, user information indicative of the user who has instructed the printing this time, date and time information of the printing this time, a print copy number and a page number corresponding to the printed document.

In step S903, the encoding unit 406 encodes the information to be embedded, which has been generated in step S902, and generates a QR code.

In step S904, the image combining unit 407 combines the generated QR code and the image data received in step S901 (image data appropriate for printing), and generates combined image data including the QR code.

In step S905, the trace information generation unit 409 generates trace information based on the newly generated information to be embedded which has been generated in step S902. Details of the trace information will be described in detail below with reference to FIG. 10.

In step S906, the data transmission/reception unit 411 records the trace information generated in step S905 in the mass-storage unit 305. The recorded trace information is transmitted from the data transmission/reception unit 401 to the server 104. Since the recording method of the trace information and the transmission method of the information to the server 104 are similar to the methods described above in step S610, their descriptions are not repeated.

In step S907, the print processing unit 408 forms and outputs the generated combined image data on a recording medium as an image. Then, the printed document is discharged on a discharge tray (not illustrated). If the print processing is to be given priority over other processing such as the trace information generation processing and the trace information record processing, the print processing in step S907 can be executed prior to or in parallel with the trace information generation processing in step S905 and the trace information record processing in step S906.

Then, the trace information generated by the MFP 102 or the MFP 103 in the process of the copy processing and the print processing will be described.

FIGS. 10A to 10C illustrate examples of the trace information generated by the MFP 102 or the MFP 103.

The trace information illustrated in FIGS. 10A to 10C is broadly classified into “input trace information” and “output trace information”. The embedded information of the original document extracted in step S603, in other words, the first information, is set in the columns of the “input trace information” if copying is instructed by the user. The columns of the “input trace information” do not contain information if the user instructs printing of the document. Further, even if the user instructs copying of the document, if the detection of the QR code from the original document fails or the decoding of the detected QR code fails, information is not displayed in the columns of the “input trace information”.

Further, the embedded information updated in step S605 (second information) is displayed in the columns of the “output trace information” if the user instructs copying of the document and, further, the detection of the QR code from the original document and the decoding of the detected QR code have been successfully accomplished.

If the user instructs copying of the document but the detection of the QR code from the original document has been unsuccessful, or even if the QR code has been detected, if the decoding of the detected QR code has been unsuccessful, the information to be embedded, which has been newly generated in step S606, will be displayed in the columns.

On the other hand, if the user instructs printing of the document, the information generated in step S902 will be displayed in the columns.

The trace information illustrated in FIGS. 10A to 10C will be described below.

The information in FIG. 10A is trace information generated by the trace information generation unit 409 of “MFP-0001” when a user, “Suzuki”, instructed the “MFP-0001” to print a document via a PC or the like at “2008/01/30 09:53:13”.

Further, the information in FIG. 10A is trace information of the second page of the first set. Since the document is printed based on the image data transmitted from the PC, the detection of the QR code is not performed. Thus, the columns of the “input trace information” are blank. Each of the columns of the “output trace information”, which are “user information”, “date and time information”, “print copy number”, “page number”, and “apparatus information” is in accordance with the “original user information”, “date and time information”, “print copy number”, “page number”, “apparatus information” of the embedded information illustrated in FIG. 7.

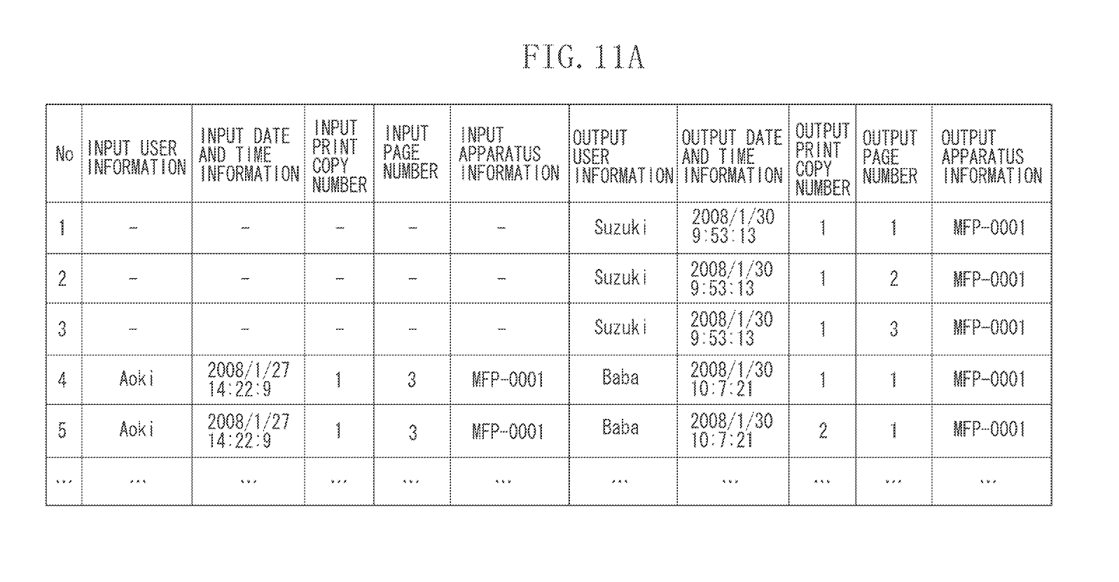

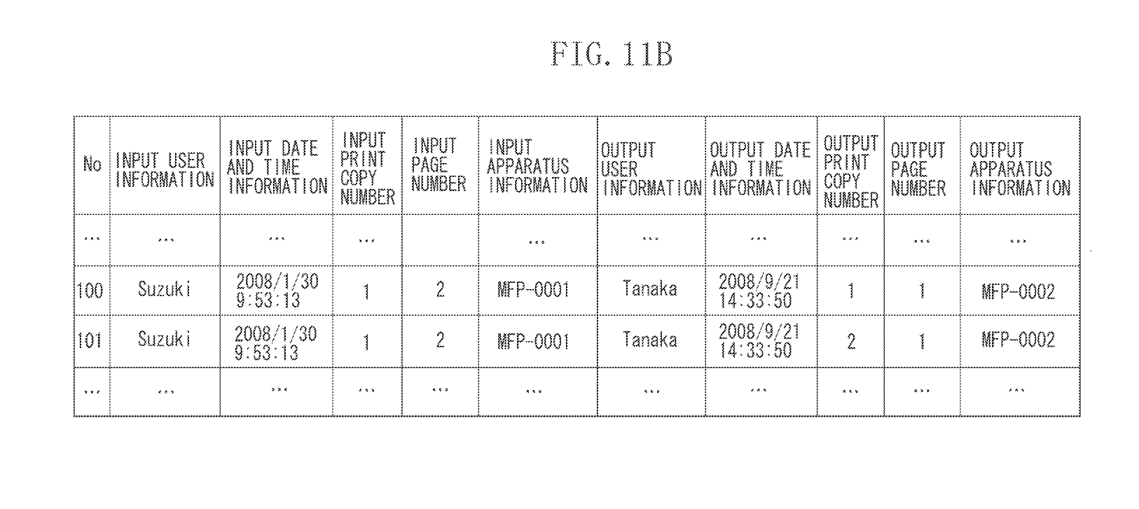

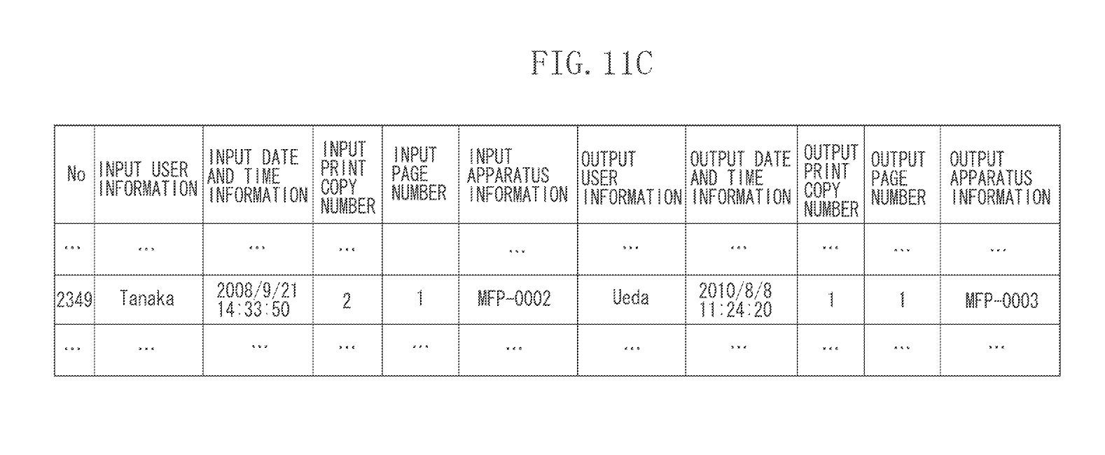

Similar trace information is generated for each page having a different print copy number or a page number (see FIGS. 11A to 11C).

The information in FIG. 10B is trace information generated by the trace information generation unit 409 of “MFP-0002” when a user, “Tanaka”, instructed the “MFP-0002” to copy a document at “2008/09/21 14:33:50”. The document to be copied is the document which has been printed when the trace information described above with reference to FIG. 10A has been generated. The embedded information before the update (i.e., the information embedded in the original document) is displayed in the columns of the “input trace information”.

Since the information is displayed in the columns, the detection processing of the QR code of the original document and the decoding processing of the detected QR code have been successfully accomplished when the copying has been performed. In such a case, the “input trace information” in FIG. 10B will be exactly the same as the “output trace information” in FIG. 10A. Further, each column of the “user information”, “date and time information”, “print copy number”, “page number”, and “apparatus information” of the “output trace information” in FIG. 10B is exactly the same as the “latest user information”, “date and time information”, “print copy number”, “page number”, and “apparatus information” of the embedded information illustrated in FIG. 8A.

The information in FIG. 10C is trace information generated by the trace information generation unit 409 of “MFP-0003” when a user, “Ueda”, instructed the “MFP-0003” to copy a document at “2010/08/08 11:24:20”. The document to be printed is the document which has been printed when the trace information described above with reference to FIG. 10B has been generated. The embedded information before the update (i.e., the information embedded in the original document) is displayed in the columns of the “input trace information”. Thus, the “input trace information” in FIG. 10C will be exactly the same as the “output trace information” in FIG. 10B.

According to the present embodiment, the server 104 stores the trace information transmitted from the MFP 102 or 103. Details of this processing will be described in detail below.

When the data transmission/reception unit 411 of the server 104 receives the trace information transmitted from the MFP 102 or 103, the trace information is sent to the trace information storing processing unit 412 by the control unit 410.

FIGS. 11A to 11C illustrate examples of data tables generated by the trace information storing processing unit 412.

The data tables are generated for each MFP that generates the trace information. Since one data table is generated for one MFP, when the trace information search unit 415 performs the tracing, a data table to be searched is confined to one data table based on the apparatus information included in such trace request. Accordingly, tracing processing can be efficiently performed.

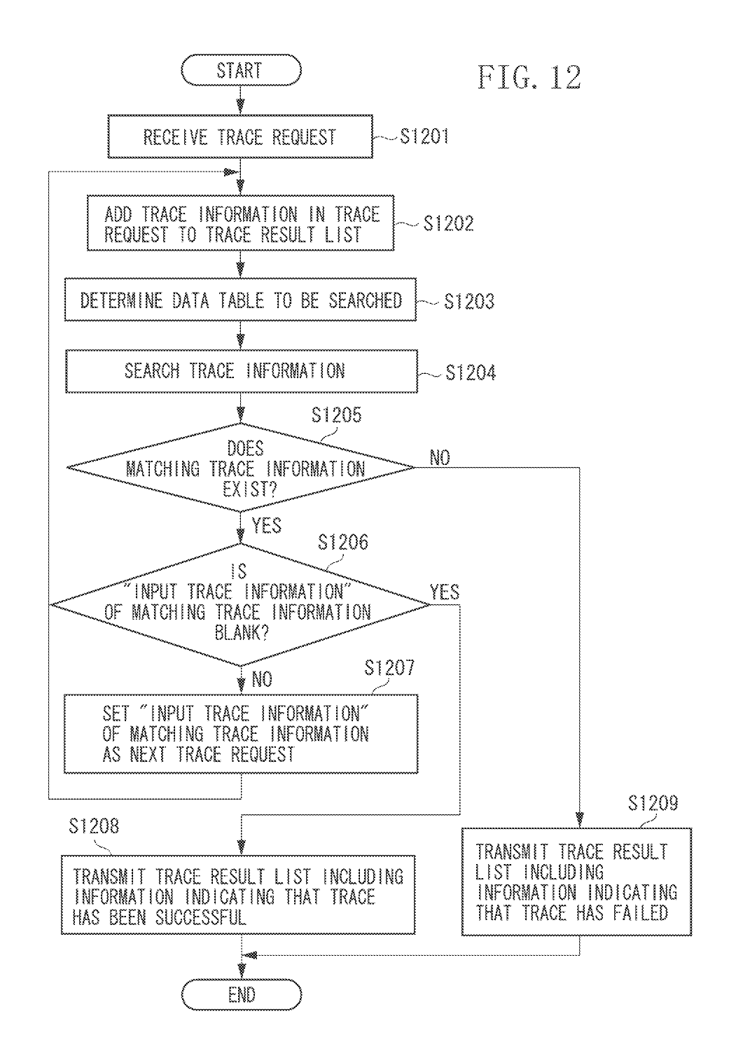

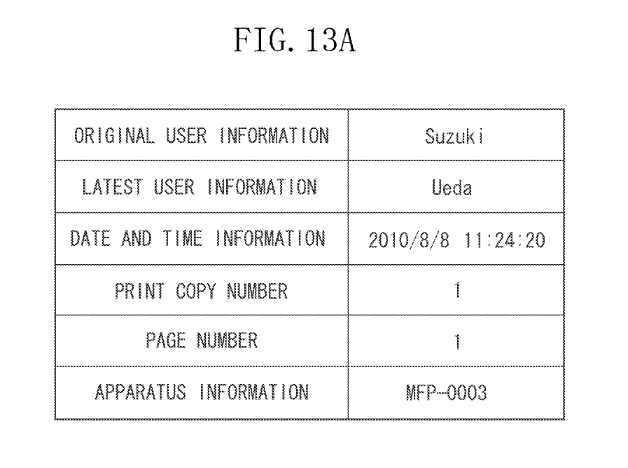

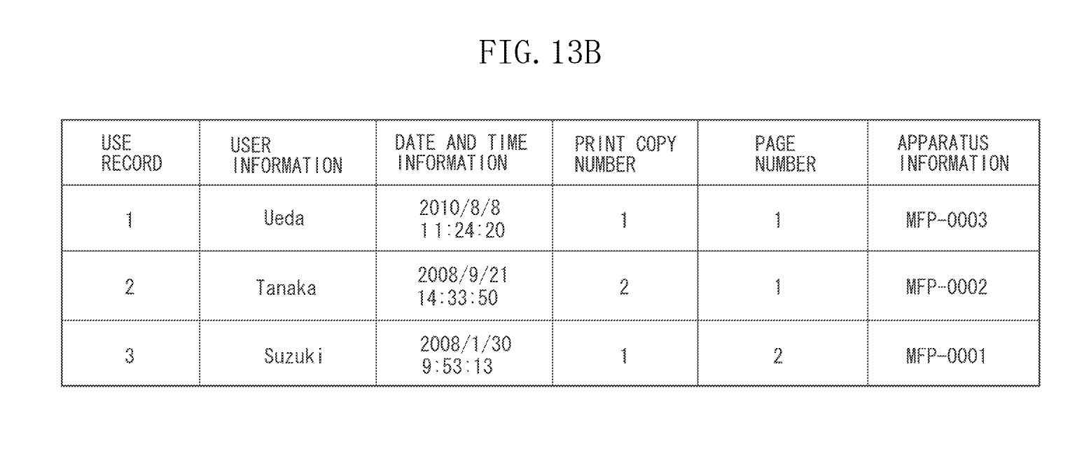

The details of the tracing processing will be described with reference to FIGS. 12, 13A, and 13B.

According to the examples illustrated in FIGS. 11A to 11C, since three data tables are generated, the server 104 has received trace information from three MFPs. The “input user information”, “input date and time information”, “input print copy number”, “input page number”, and “input apparatus information” in FIGS. 11A to 11C correspond to the “input trace information” in FIGS. 10A to 10C.

Similarly, the “output user information”, “output date and time information”, “output print copy number”, “output page number”, “output apparatus information” in FIGS. 11A to 11C correspond to the “output trace information” in FIGS. 10A to 10C.

FIG. 11A illustrates a data table where trace information generated by the trace information generation unit 409 of the “MFP-0001” is stored. Thus, “MFP-0001” is in all the columns of the “output apparatus information” of the trace information stored in the data table illustrated in FIG. 11A. “No.” is an identifier used for the unique identification of the trace information in the data table. According to the present embodiment, the numbers displayed in the “No.” columns are sequential numbers representing the order in which the trace information has been stored in each data table.

In FIG. 11A, the same information is displayed in the “output date and time information” of trace information of Nos. 1 to 3. This is because the trace information of Nos. 1 to 3 is generated according to one print command.

In other words, the trace information of Nos. 1 to 3 indicates that the user, “Suzuki”, has printed one set of a document that consists of three pages at “2008/01/30 09:53:13” by “MFP-0001”. Similarly, trace information of Nos. 4 and 5 indicates that a user, “Baba”, has copied two sets of an original document which consists of one page using the “MFP-0001” at “2008/01/30 10:07:21”.

Further, the trace information indicates that the original document copied by “Baba” is the third page of the first set of the document printed or copied by a user, “Aoki”, using the “MFP-0001” at “2008/01/27 14:22:09”.

FIG. 11B illustrates a data table where trace information generated by the trace information generation unit 409 of the “MFP-0002” is stored. Thus, “MFP-0002” is in all the columns of the “output apparatus information” of the trace information stored in the data table illustrated in FIG. 11B.

In FIG. 11B, trace information of Nos. 100 and 101 indicates that the user, “Tanaka”, has printed two sets of an original document that consists of one page by the “MFP-0002” at “2008/09/21 14:33:50”. Further, the trace information indicates that the original document is the second page of the first set of the document which has been printed or copied by the user, “Suzuki”, using the “MFP-0001” at “2008/01/30 09:53:13”.

FIG. 11C illustrates a data table where trace information generated by the trace information generation unit 409 of the “MFP-0003” is stored. In FIG. 11C, trace information of No. 2349 indicates that the user, “Ueda”, has printed one set of an original document which consists of one page using the “MFP-0003” at “2010/08/08 11:24:20”.

Further, the trace information indicates that the original document printed by the user, “Ueda”, is the first page of the second set of the document which has been printed or copied by the user, “Tanaka”, using “MFP-0002” at “2008/09/21 14:33:50”.

The trace information in FIG. 10A corresponds to the trace information No. 2 in FIG. 11A. Similarly, the trace information in FIG. 10B corresponds to the trace information No. 101 in FIG. 11B. Further, the trace information in FIG. 10C corresponds to the trace information No. 2349 in FIG. 11C.

The server 104 performs the tracing processing based on the trace information stored in the tables illustrated in FIGS. 11A to 11C. The tracing processing will now be described below.

FIG. 12 is a flowchart illustrating the tracing processing performed by the trace information search unit 415 of the server 104.

According to the present embodiment, a tracing instruction is submitted when the user sets the document as a trace target on the platen and selects a tracing execution button (not illustrated) displayed on the display unit 301. The MFP scans the document as the trace target according to the tracing instruction from the user, extracts the embedded information, and transmits the extracted embedded information to the server 104 as a trace request.

In step S1201, the data transmission/reception unit 411 receives the trace request from the MFP 102 or 103. This trace request includes the information embedded in the document as the trace target extracted by the scanning performed by the MFP 102 or 103.

The receiving method of the trace request is not limited to the above-described method. If the server 104 includes a decoding function (not illustrated), the server 104 can extract the embedded information from an image of an undecoded QR code transmitted from the MFP. In this manner, regardless of whether the embedded information is to be received or extracted by the server, information embedded in the document can be acquired. Moreover, a source of the trace request is not limited to a MFP and, for example, a mobile terminal (not illustrated) including a camera or an application (not illustrated) which runs on the PC 101 can also be used.

In step S1202, the trace information search unit 415 adds the trace request received in step S1201 to a trace result list.

In step S1203, the trace information search unit 415 determines the data table to be searched according to the trace request received in step S1201. To be more precise, a data table whose apparatus information is the same as the apparatus information included in the trace request received in step S1201 is determined as a data table to be searched.

In step S1204, from the data table determined in step S1203, the trace information search unit 415 searches the trace information that matches the trace request. To be more precise, the trace information search unit 415 searches the “output date and time information”, “output print copy number”, and “output page number” in the data table that match the “date and time information”, “print copy number”, and “page number” in the trace request.

In step S1205, the trace information search unit 415 determines whether trace information that matches the trace request exists in the target data table determined in step S1203. If matching trace information exists (YES in step S1205), the processing proceeds to step S1206. If matching trace information does not exist (NO in step S1205), the processing proceeds to step S1209.

In step S1206, the trace information search unit 415 determines whether the columns of the “input trace information” of the trace information that matched in step S1204 are blank. If the columns of the “input trace information” are blank (YES in step S1206), the processing proceeds to step S1208. If the columns of the “input trace information” are not blank (NO in step S1206), the processing proceeds to step S1207.

In step S1207, the trace information search unit 415 sets, as a next trace request, the input trace information corresponding to the matching trace information. Then, the processing returns to step S1202 and the tracing processing is continued according to the new trace request.

In step S1208, the trace information search unit 415 transmits information indicating that the tracing has been successfully accomplished together with the trace result list to the MFP 102 or 103 via the data transmission/reception unit 411.

On the other hand, in step S1209, the trace information search unit 415 transmits information indicating that the tracing has been unsuccessful together with the trace result list to the MFP 102 or 103 via the data transmission/reception unit 411.

The trace result list is displayed by the MFP 102 or 103.

FIG. 13A illustrates an example of the trace target and FIG. 13B illustrates an example of the trace result list. The information in FIG. 13A is information embedded in the document as the trace target. This information is included in the trace request received by the server 104 in step S1201. The trace result list in FIG. 13B is the list transmitted from the server 104 in step S1208.

Generation processing of the trace result list in FIG. 13B based on the trace request received in step S1201 will be described. The information embedded in the document to be traced is illustrated in FIG. 13A.

The trace result list does not contain any information when the tracing processing starts. After the trace request is received in step S1201, in step S1202, the trace information is added to the line of use history “1” of the trace result list based on the embedded information in FIG. 13A. In step S1203, based on the apparatus information included in the trace request, the data table of “MFP-0003” is determined as a data table to be searched. In other words, the data table illustrated in FIG. 11C is determined as a data table to be searched regarding the example illustrated in FIG. 13A.

In step S1204, trace information including output information indicative of date and time “2010/08/08 11:24:20”, print copy number “1”, and page number “1” is searched from the data table of “MFP-0003”. According to the example in FIG. 11C, trace information No. “2349” matches such condition.

In step S1207, based on the input trace information corresponding to the matching trace information, a next trace request is set by the trace information search unit 415, and the processing returns to step S1202. Thus, in step S1202, the input trace information of No “2349” in FIG. 11C is added to the line of use record “2” in FIG. 13B.

Further, in step S1203, a data table to be searched next is set to the “MFP-0002”. In step S1204, from the data table of the “MFP-0002” illustrated in FIG. 11B, trace information including output information indicative of date and time “2008/09/21 14:33:50”, print copy number “2”, and page number “1” is searched. According to the example illustrated in FIG. 11B, trace information No. “101” matches such condition.

Based on the input trace information corresponding to the matching trace information, a next trace request is set in step S1207. Then, in step S1202, a line of use record “3” is added to FIG. 13B according to similar processing. Further, in step S1205, it is determined that trace information No “2” in FIG. 11A matches such condition. Since input trace information that corresponds to the matching trace information is blank, the processing proceeds from step S1206 to step S1208, and then the tracing processing ends.

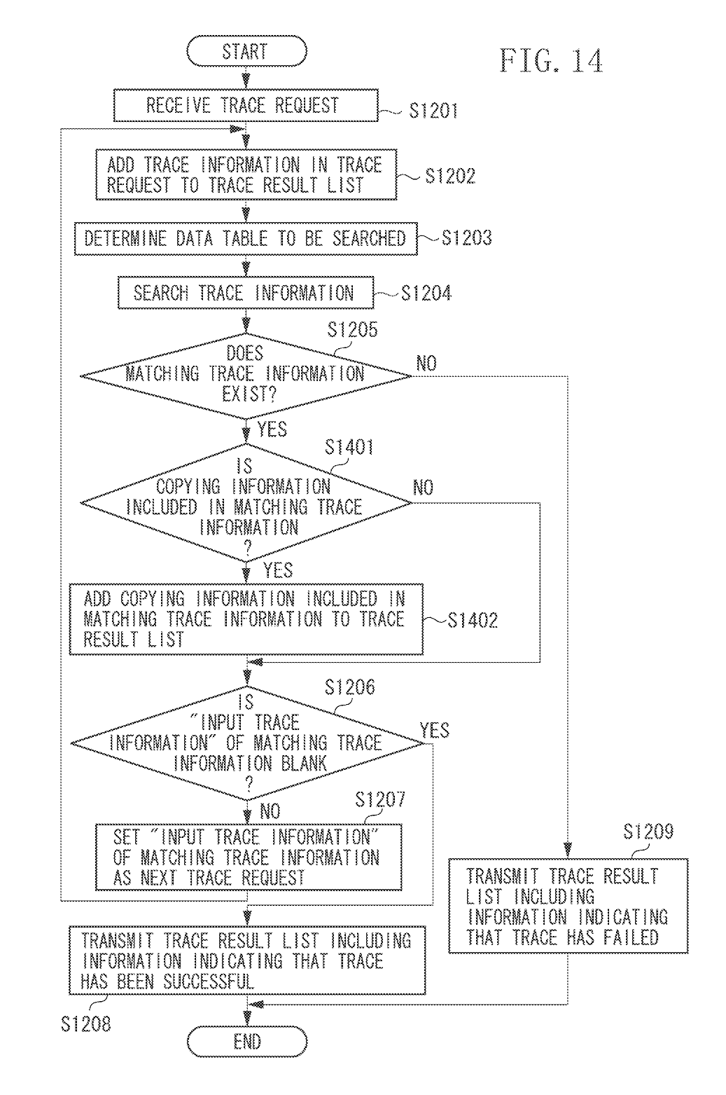

FIG. 14 is a flowchart illustrating a processing flow of the trace information search unit 415 of the server 104 tracing information including copying information. The copying information is information indicating that a plurality of print copies of a document being the trace target has been printed. Since the processing in steps S1201 to S1209 in FIG. 14 is similar to the processing in the steps having the same step number in FIG. 12, only the processing in steps S1401 and S1402 will be described.

In step S1401, the trace information search unit 415 determines whether copying information exists in the trace information that matched the trace request in step S1204. In other words, the trace information search unit 415 determines whether a record indicating that a plurality of print copies has been printed for the same document is included in the “output trace information” of the trace information that matched the trace request. Whether a plurality of print copies has been printed for the same document is determined according to whether a record with the same “output user information”, “output time and date information”, “output page number”, and “output apparatus information” but with a different “output print copy number” exists in the “output trace information”. If copying information exists in the trace information (YES in step S1401), the processing proceeds to step S1402. If copying information does not exist in the trace information (NO in step S1401), the processing proceeds to step S1206.

In step S1402, the trace information search unit 415 adds the copying information detected in step S1401 to the trace result list.

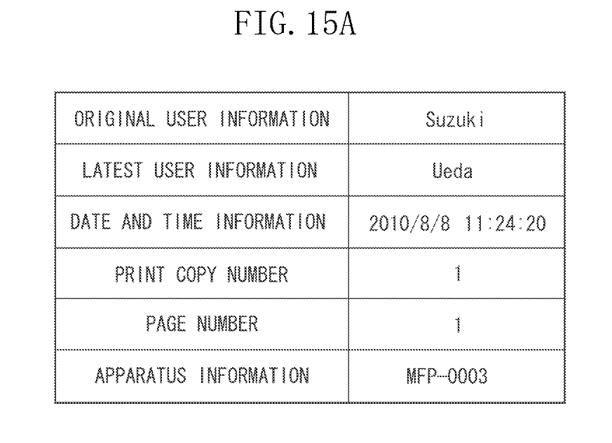

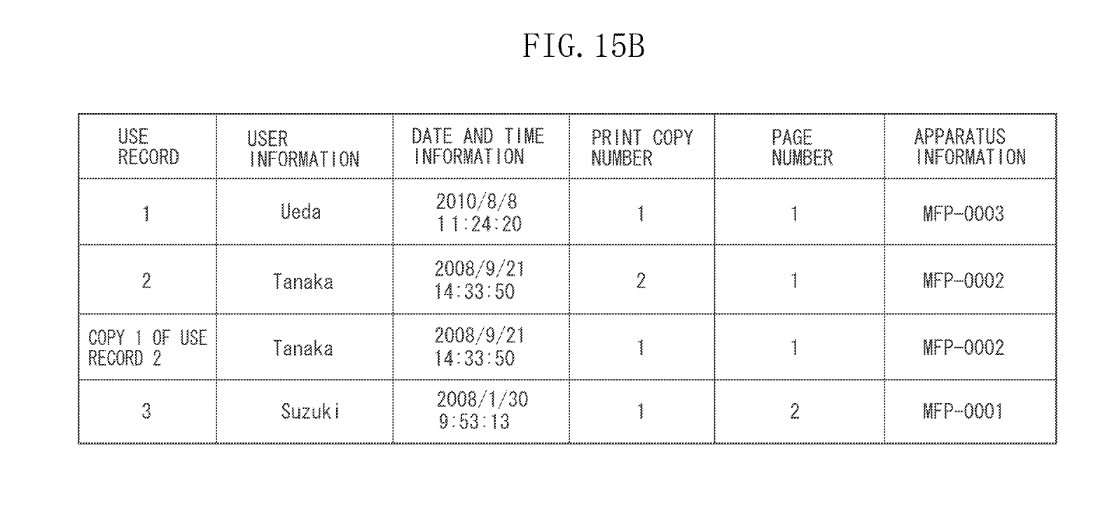

FIG. 15A illustrates an example of a trace target and FIG. 15B illustrates a trace result list. Since FIG. 15B is similar to FIG. 13 except that copying information is included in the trace result list, only the copying information will be described.

According to the flowchart in FIG. 14, if trace information is searched based on embedded information in FIG. 15A, when the processing proceeds to step S1207 for the first time, the trace result list in FIG. 15B includes a line of use record “1”. In step S1207, the trace information search unit 415 sets, as a next trace request, input trace information No. “2349” in FIG. 11C to the next trace request, and the processing returns to step S1202. In step S1202, the trace information search unit 415 adds the input trace information No. “2349” in FIG. 11C to the line of use record “2” in FIG. 15B. In step S1204, the trace information search unit 415 searches for the trace information No. “101” in FIG. 11B that matches the trace request. The output trace information No. “100” in FIG. 11B is the same as the output trace information No. “101” except for the print copy number. In other words, both the trace information No. “100” and the trace information No. “101” are trace information of the same document when a plurality of print copies is printed. The trace information No. “100” corresponds to its print copy number and so does the trace information No. “101”. Thus, in step S1401, the trace information search unit 415 determines that the trace information No. “100” is a copy of the trace information No. “101”.

Thus, in the trace result list in FIG. 15B, a line of “copy 1 of use record 2” follows the line of use record “2”. This is the copying information recorded in step S1402.

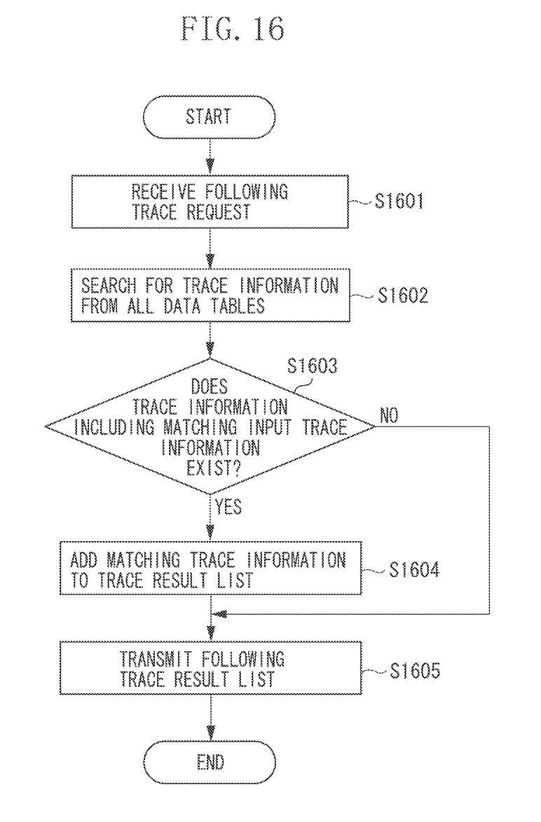

FIG. 16 is a flowchart illustrating a processing flow of the trace information search unit 415 of the server 104 performing the following trace. Although normal trace processing illustrated in the flowchart in FIG. 12 traces the past use record of the trace target document, the following trace traces subsequent use records.

In step S1601, the data transmission/reception unit 411 receives a following trace request from the MFP 102 or 103. The trace request includes information embedded in the trace target document. The embedded information is scanned and extracted by the MFP 102 or 103 and added to the trace request. The trace request is not limited to such a type and the embedded information can be extracted by the server 104 after an image of the QR code is received by the server 104 as is the trace request in step S1201.

In step S1602, the trace information search unit 415 searches for the trace information that matches the trace request from all the data tables. To be more precise, the trace information search unit 415 searches for the trace information whose “input time and date information”, “input print copy number”, and “input page number” in the data tables matches “time and date information”, “print copy number”, and “output page number” in the trace request. When the following trace processing is performed, a next apparatus that processes the document as the trace target is uncertain. Thus, unlike the trace processing in FIG. 12, the data table from which the trace information is to be searched cannot be narrowed down to a certain table. Accordingly, the trace information is searched from all the data tables.

In step S1603, the trace information search unit 415 determines whether trace information that matches the trace request exists in any of the data tables. If trace information that matches the trace request exists (YES in step S1603), the processing proceeds to step S1604. If trace information that matches the trace request does not exist (NO in step S1603), it means that the trace has been suspended, and the processing proceeds to step S1605.

In step S1604, the trace information search unit 415 adds the trace information that matched the trace request in step S1602 to the trace result list. Although there may be a plurality of pieces of matching trace information, all pieces of such information are added to the trace result list.

In step S1605, the trace information search unit 415 transmits the trace result list together with information indicating that the trace has been successful to the MFP 102 or 103 via the data transmission/reception unit 411. If matching trace information does not exist, the trace information search unit 415 transmits an empty trace result list to the MFP 102 or 103.

The trace result list is displayed by the MFP 102 or 103.

Regarding the flowchart in FIG. 16, only one search is performed for one following trace request since the load of the following trace is higher than the normal trace processing. This is because, as described above, it is difficult to narrow down the search target data tables and, accordingly, a plurality of pieces of trace information that matches the trace request may be included in the data tables. As is the case with step S1207 in FIG. 12, output information of each piece of trace information that matches the trace request can be set as a next trace request after step S1604. Then, the processing returns to step S1602 and the following trace processing is continued.

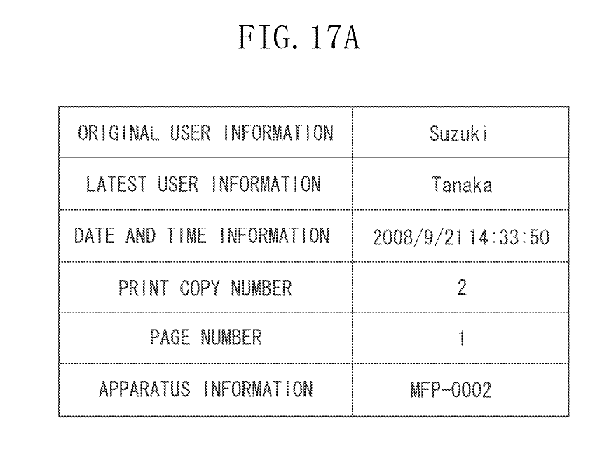

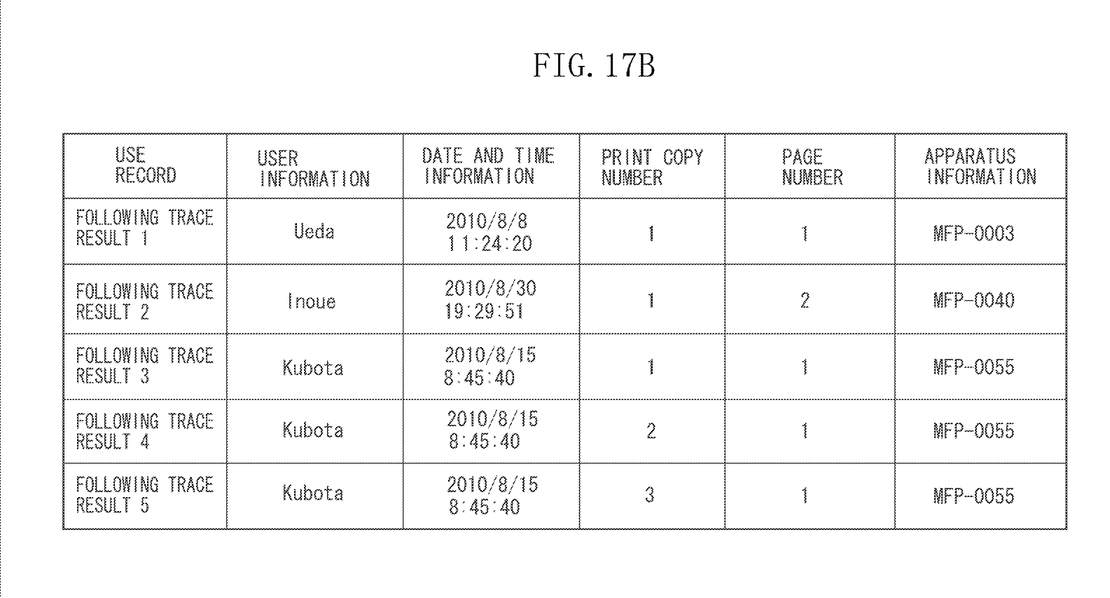

FIG. 17A illustrates an example of a trace target of the following trace processing and FIG. 17B illustrates an example of a trace result list. The trace target in FIG. 17A is information embedded in the document of the trace target included in the following trace request which the server 104 received in step S1601. FIG. 17B is a trace result list transmitted in step S1605. In the following description, a generation process of the trace result list illustrated in FIG. 17B based on the trace request in FIG. 17A will be described.

The trace result list does not include any information when the trace processing starts. In step S1602, trace information with input information of time and date information “2008/09/21 14:33:50”, print copy number “2”, and page number “1” is searched from each data table. According to the example in FIG. 11C, trace information No. “2349” matches this condition.

In step S1604, the trace information search unit 415 adds the information that matched the trace request to the trace result list. In other words, the input trace information No. “2349” of the trace information in FIG. 11C is added to the line of use record “following trace result 1” in FIG. 17B.

Similarly, regarding the trace result list in FIG. 17B, since trace information of “following trace result 2” to “following trace result 5” matches the trace request in FIG. 17A, the information is added to the trace result list. The trace information of “following trace result 2” to “following trace result 5” is not illustrated in FIG. 11. According to this trace result list, it is known that five copies of the document being the trace target have been made.

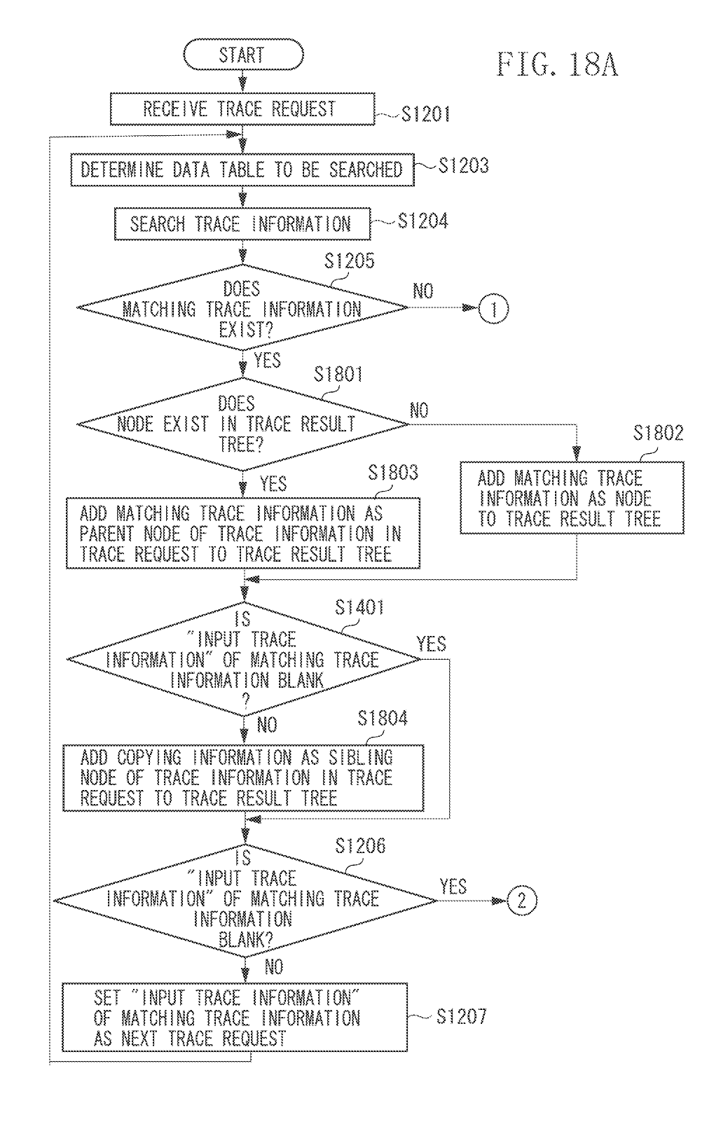

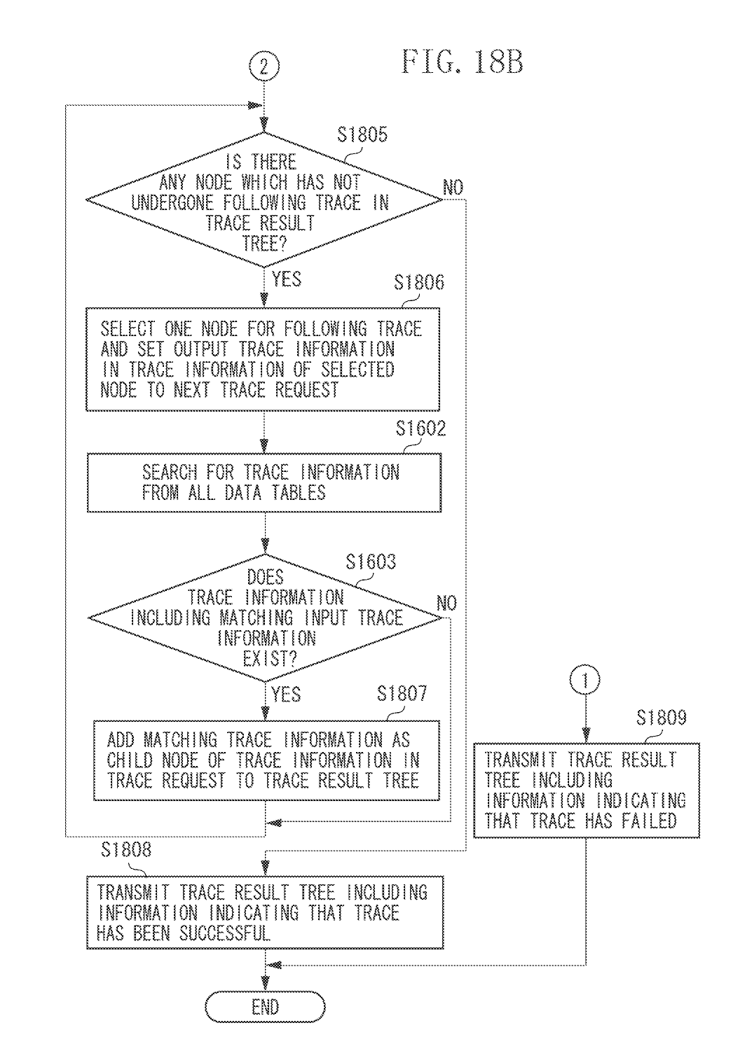

FIGS. 18A and 18B are flowcharts illustrating a processing flow of the trace information search unit 415 of the server 104 performing full tracing. The full tracing is a method for tracing all the use records of a document as a trace target by combining the normal trace processing including the tracing of copying information and the following trace processing. Same numerals are assigned to steps in FIG. 18A, which are described above with reference to FIGS. 12 and 14, so that the descriptions of such steps are not repeated.

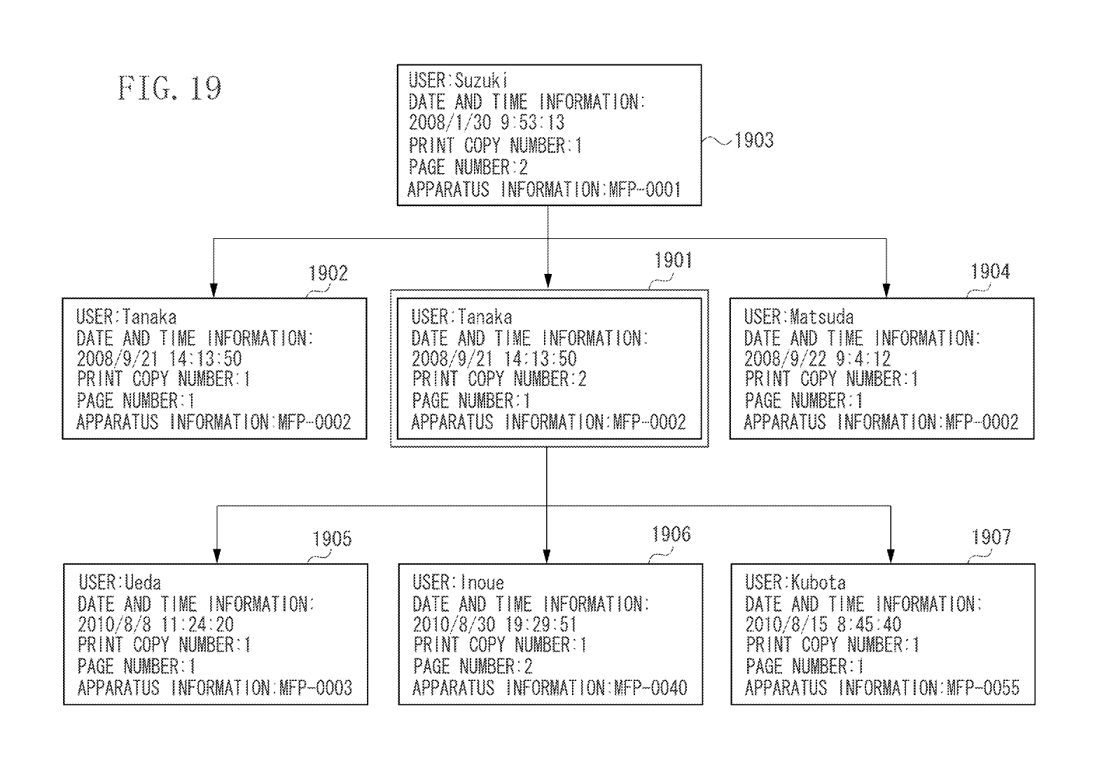

In step S1801, the trace information search unit 415 determines whether trace information including output trace information that matches the trace request exists. In other words, the trace information search unit 415 determines whether a node exists in a trace result tree. If a node does not exist in the trace result tree (NO in step S1801), the processing proceeds to step S1802. If a node exists in the trace result tree (YES in step S1801), the processing proceeds to step S1803. The trace result tree is a data structure useful for presenting a use record of a document being a trace target. The trace result tree has a general tree structure and each node of the tree corresponds to a use record. A root node is original trace information. In FIGS. 12 to 17B, although the trace result is presented in a table format, it can be presented in a tree structure as is the trace result displayed in FIG. 19 described below. Any internal data storage method such as a tree structure or a table format can be used so long as the order of the use records can be expressed. Regarding the table format employed in FIGS. 12 to 17B, the order of the use records is given in the row of the “use record”. Further, regarding the tree structure in FIG. 19, the order of the use records is expressed by a parent-child relation of the nodes.

In step S1802, the trace information search unit 415 adds the trace information that matched the trace request to the trace result tree as a node. Then, the processing proceeds to step S1401.

In step S1803, the trace information search unit 415 adds the trace information that matched the trace request to the trace result tree as a parent node of the trace information in the trace request.

In step S1804, if copying information exists in the trace information that matched the trace request in step S1401, the trace information search unit 415 adds the copying information to the trace result tree as a sibling node of the trace information in the trace request.

In the flowcharts in FIGS. 18A and 18B, processing in steps before step S1805 is the normal trace processing including the tracing of copying information and processing in steps on and after step S1805 is the following trace processing. In step S1805, the trace information search unit 415 determines whether a node which has not yet undergone the following trace processing exists in the nodes of the trace result tree. If the following trace processing has been completed with respect to all the nodes (NO in step S1805), the processing proceeds to step S1808. If a node which has not yet undergone the following trace processing exists (YES in step S1805), the processing proceeds to step S1806.

In step S1806, the trace information search unit 415 selects one node for the following trace processing, and sets the output trace information in the trace information of that node to the next trace request.

In step S1807, the trace information search unit 415 adds the trace information that matched the trace request to the trace result tree as a child node of the trace information in the trace request, and then the processing returns to step S1805. If a plurality of pieces of trace information that matched the trace request exists, all of them are added to the trace result tree. The trace information that already exists in the trace result tree as a child node, however, is not added. The child node added in step S1807 is determined not yet to be undergone the following trace processing in step S1805.

In step S1808, the trace information search unit 415 transmits the trace result tree together with information indicating that the trace has been successful to the MFP 102 or 103 via the data transmission/reception unit 411.

In step S1205, if matching trace information does not exist (NO in step S1205), the processing proceeds to step S1809. In step S1809, the trace information search unit 415 transmits the trace result tree together with information indicating that the trace has failed to the MFP 102 or 103 via the data transmission/reception unit 411.

FIG. 19 illustrates an example of a display screen of a trace result tree. The trace result tree in FIG. 19 shows the result of the trace processing which has been performed according to the flowcharts in FIGS. 18A and 18B. The trace target is the trace information in FIG. 17A.

The trace result tree is empty when the trace processing starts. In step S1204, the trace information search unit 415 searches for the trace information that matches the trace request in the data table of “MFP-0002”. As a result, the trace information No. “101” in FIG. 11B matches the trace request. In step S1801, since the trace result tree does not have any node, the processing proceeds to step S1802. In step S1802, the trace information search unit 415 adds the trace information that matched the trace request as a node to the trace result tree (trace information 1901).

In step S1401, the trace information search unit 415 determines whether copying information is included in the trace information that matched the trace request. According to the example in FIG. 11B, the trace information No. “100” exists as the copying information of the trace information No. “101” that matched the trace request. Thus, the processing proceeds to step S1804, and the trace information search unit 415 adds the trace information of the copying information to the trace result tree as a sibling node of the trace information that matched the trace request (trace information 1902).

In step S1207, the trace information search unit 415 sets the input trace information of the trace information 1901 to a new trace request, and the processing returns to step S1203.

Similarly, in step S1204, the trace information search unit 415 searches for the trace information that matches the trace request in the data table of “MFP-0001”. As a result, the trace information No. “2” in FIG. 11A matches the trace request. In step S1801, since a node already exists in the trace result tree, the processing proceeds to step S1803. In step S1803, the trace information that matched the trace request is added to the trace result tree as a parent node of the trace information in the trace request (trace information 1903).

In step S1401, the trace information search unit 415 determines whether copying information exists in the trace information that matched the trace request. According to the example in FIG. 11A, since copying information of the trace information No. “2” that matched the trace request does not exist, the processing proceeds to step S1206. In step S1206, since the input trace information of the trace information No. “2” that matched the trace request is blank, the processing proceeds to step S1805.

The steps described above configure the normal trace processing including trace processing of copying information. Trace information having blank input trace information will be the root node of the trace result tree. According to the tree structure in FIG. 19, the trace information 1903 is the root node. Processing on and after step S1805 is the following trace processing.

In step S1805, the trace information search unit 415 determines whether a node which has not yet undergone the following trace exists in the trace result tree. If the processing in step S1805 is executed for the first time, any of the nodes has not yet undergone the following trace processing.

In step S1806, the trace information search unit 415 selects one node out of the nodes which have been determined that they have not yet undergone the following trace processing in step S1805 and sets the output trace information of the trace information to the trace request. According to the example in FIG. 19, the trace information 1903, which is the root node, is selected.

In step S1603, the trace information search unit 415 determines whether trace information that matches the trace request exists in any of the data tables. If trace information that matches the trace request exists, in step S1807, the trace information search unit 415 adds the trace information that matched the trace request as a child node of the trace information in the trace request. According to the example in FIG. 19, as the following trace processing of the trace information 1903, all of the pieces of trace information 1901, 1902, and 1904 match the trace request according to the search in step S1602. Since both the trace information 1901 and the trace information 1902 are already added to the trace result tree, the child node added in step S1807 is only the trace information 1904.

Then, the processing returns to step S1805. In step S1805, the trace information search unit 415 determines whether a node which has not yet undergone the following trace processing exists. At this point, the nodes which have not yet undergone the following trace processing are the trace information 1901, 1902, and 1904.

According to the example in FIG. 19, matching trace information does not exist if following trace processing is executed for the trace information 1902 and the trace information 1904. Thus, neither one of the pieces of trace information 1902 and 1904 in the trace result tree has a child node. On the other hand, if following trace processing is executed for the trace information 1901, all of the pieces of trace information 1905, 1906, and 1907 match the trace request. Thus, all of the pieces of trace information 1905, 1906, and 1907 are added to the trace result tree as child nodes of the trace information 1901.

Similarly, the following trace processing is sequentially executed with respect to the trace information 1905, 1906, and 1907. According to the example in FIG. 19, since trace information that matches the trace request in the following trace processing does not exist in any of pieces of trace information 1905, 1906, and 1907, such trace information does not have a child node.

When the following trace processing of all the nodes of the trace result tree is finished, the trace result tree is completed. By using this trace result tree, all the use records of a document being a trace target can be traced. According to the example in FIG. 19, it is known that the document in FIG. 17A being the trace target has been first printed by the user “Suzuki” (trace information 1903). Then, copying of the document is repeated, so that seven documents are generated.

Aspects of the present invention can also be realized by a computer of a system or apparatus (or devices such as a CPU or MPU) that reads out and executes a program recorded on a memory device (computer-readable medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-054464 filed Mar. 11, 2011 and No. 2012-028889 filed Feb. 13, 2012, which are hereby incorporated by reference herein in their entirety.

What is claimed is:

1. An output apparatus comprising:
a generation unit configured to generate a two-dimensional code by encoding information indicative of the output apparatus, information indicative of an output time of an image output by the output apparatus, and information indicative of a page number and a print copy number when the image is output;
a combining unit configured to combine the generated two-dimensional code with the image; and
an output unit configured to output the image including the two-dimensional code.

2. A system comprising:
a storage unit configured to store first information including information indicative of an output apparatus for an image, information indicative of an output time of the image output by the output apparatus, information indicative of a page number and a print copy number when the image is output, and information indicative of a user who has instructed the output apparatus to output the image in association with second information including information indicative of an output apparatus for an image as an original image of the image, information indicative of an output time of the original image by the output apparatus, information indicative of a page number and a print copy number of the original image when the original image is output, and information indicative of a user who has instructed the output apparatus to output the original image;
an acquisition unit configured to detect a two-dimensional code from an image output from the output unit of the output apparatus according to claim 1 and to acquire information indicative of the output apparatus, information indicative of the output time of the image by the output apparatus, and information indicative of the page number and the print copy number when the image is output;
a search unit configured to search the storage unit for the first information including the same information as the information indicative of the output apparatus, the information indicative of the output time of the image output by the output apparatus, and information indicative of the page number and the print copy number when the image is output acquired by the acquisition unit; and
a display unit configured to display, if the first information including the same information is found by the search unit, information indicative of the user, who has instructed the output of the original image, from among the second information which is stored in the storage unit in association with the first information including the same information.

3. A method for controlling an output apparatus, the method comprising:
generating a two-dimensional code by encoding information indicative of the output apparatus, information indicative of an output time of an image output by the output apparatus, and information indicative of a page number and a print copy number when the image is output;
combining the generated two-dimensional code with the image; and
outputting the image including the two-dimensional code.

4. A computer-readable storage medium storing a computer-readable program for causing a computer to execute the method according to claim 3.
